(19) United States
(12) Patent Application Publication
(10) Pub. No.: US 2013/0314414 A1
(43) Pub. Date: Nov. 28, 2013

(54) COMPUTING DEVICE AND METHOD OF ESTABLISHING COORDINATE SYSTEMS ON SURFACES OF OBJECTS

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventors: CHIH-KUANG CHANG, New Taipei (TW); XIN-YUAN WU, Shenzhen (CN); BO NIE, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/870,946

(22) Filed: Apr. 25, 2013

(30) Foreign Application Priority Data
May 23, 2012 (CN) 2012101614849

(51) Int. Cl. G06T 17/00

(52) U.S. Cl. CPC G06T 17/00
USPC 345/420

(57) ABSTRACT

In a method and a computing device for establishing a coordinate system on a surface of an object, a three dimensional computer aided design (CAD) model of the surface of the object is converted to a two dimensional UV plane. A triangular mesh model of the CAD model is generated. Points are selected from the triangular mesh model, and real points that corresponding to the points are sampled on the surface of the object. A conversion matrix is computed by aligning the real points and the points selected from the triangular mesh model; and the coordinate system is established according to the conversion matrix.

### BACKGROUND

1. Technical Field

Embodiments of the present disclosure relate to image measuring techniques, and more particularly to a computing device and a method of establishing coordinate systems on surfaces of objects.

2. Description of Related Art

Image measuring techniques are widely used in the measurement field for precisely, accurately, and speedily measuring objects. During measurement of an object, a coordinate system needs to be established. Usually, the coordinate system is established by selecting a point, a line, and a plane on surfaces of the object.

However, a spherical object has no flat plane on its surface, thus such a coordinate system cannot engender precision in measurements.

### BRIEF DESCRIPTION OF THE DRAWINGS

FIG. 1 is a block diagram of one embodiment of a computing device including a coordinate system establishing system.

FIG. 2 is a block diagram of one embodiment of function modules of the coordinate system establishing system in FIG. 1.

FIGS. 3A to 3D are flowcharts of one embodiment of a method for establishing coordinate system on a surface of an object.

FIG. 4 is a schematic diagram of a two dimensional UV plane.

FIG. 5 illustrates an I++ measurement program.

### DETAILED DESCRIPTION

In general, the word “module,” as used hereinafter, refers to logic embodied in hardware or firmware, or to a collection of software instructions, written in a programming language, such as, for example, Java, C, or Assembly. One or more software instructions in the modules may be embedded in firmware. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

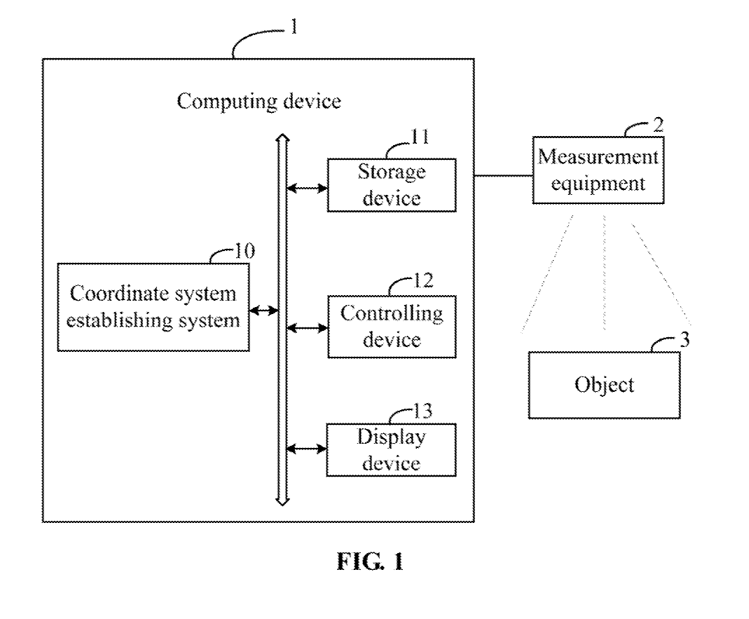

FIG. 1 is a block diagram of one embodiment of a computing device 1 including a coordinate system establishing system 10. The computing device 1 may be a computer, a server, or a personal digital assistant (PDA), for example. The computing device 1 further includes a storage device 11, a controlling device 12, and a display device 13. The computing device 1 connects to a measurement equipment 2. The measurement equipment is used to scan surfaces of an object 3. One skilled in the art recognizes that the computing device 1 may be configured in a number of other ways and may include other or different components.

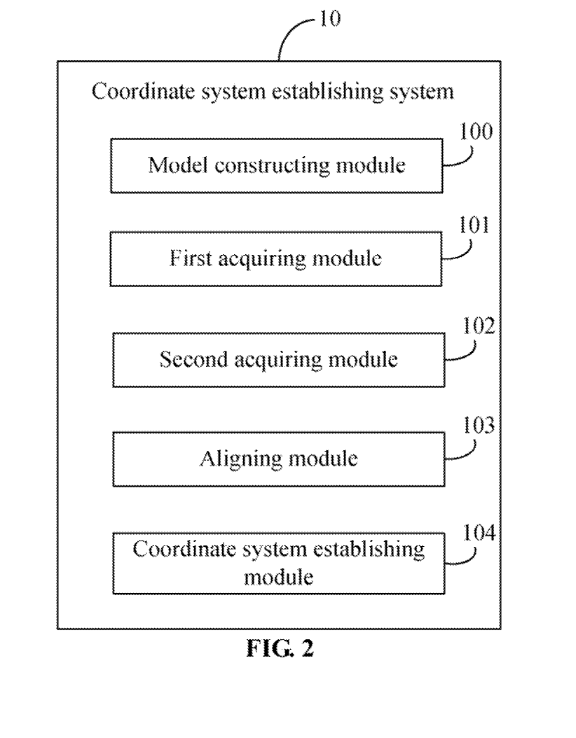

The coordinate system establishing system 10 includes computerized codes in the form of one or more programs, which are stored in the storage device 11. In present embodiment, the one or more programs of the coordinate system establishing system 10 are described in the form of function modules (see FIG. 2), which are executed by the controlling device 12 to perform functions of establishing a coordinate system on a surface of the object 3.

The storage device 11 may include some type(s) of non-transitory computer-readable storage mediums, such as a hard disk drive, a compact disc, a digital video disc, or a tape drive. In one embodiment, the storage device 11 stores data needed when establishing the coordinate system on the surface of the object 3. The data may include a computer aided design (CAD) file of each surface of the object 3. The CAD files are obtained from the scans carried out by the measurement equipment 2 and includes controlling points, weights, and nodes of the surface.

The controlling device 12 may be a processor, a microprocessor, an application-specific integrated circuit (ASIC), and a field programmable gate array, (FPGA) for example.

The display device 13 displays visible data such as graphic representations of the object 3.

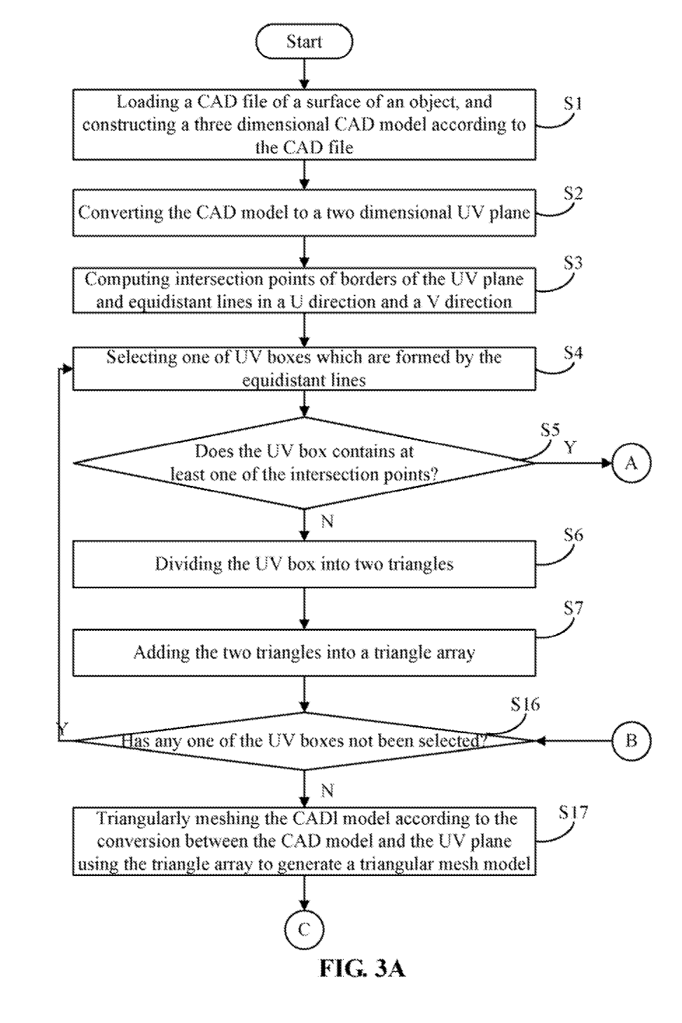

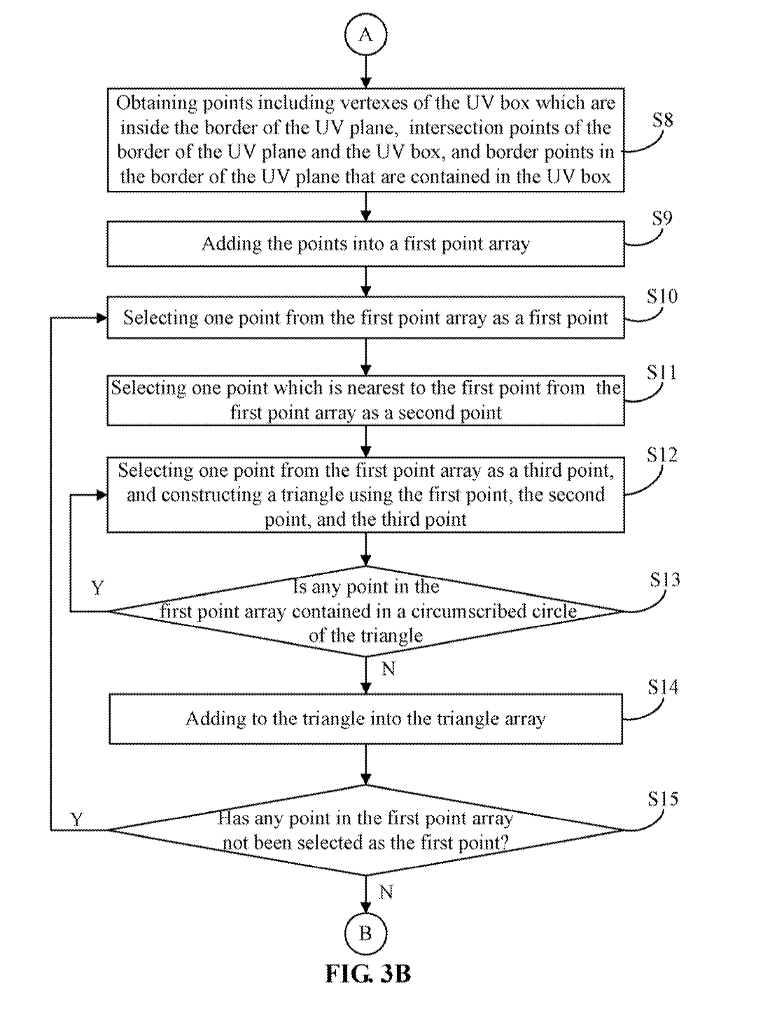

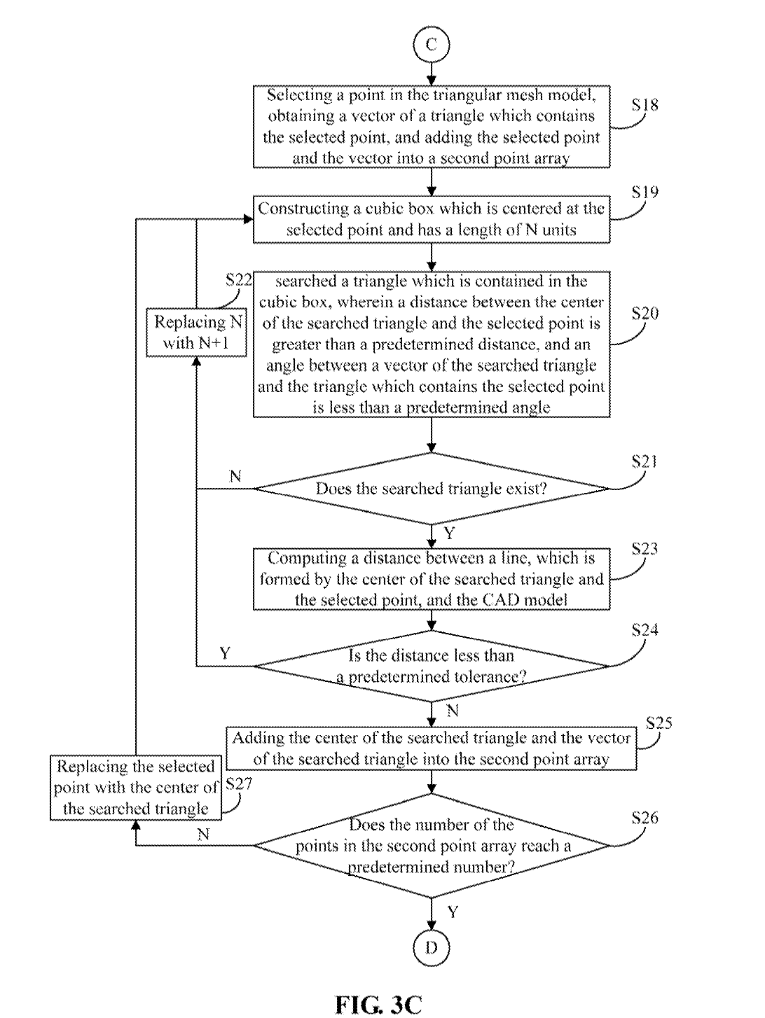

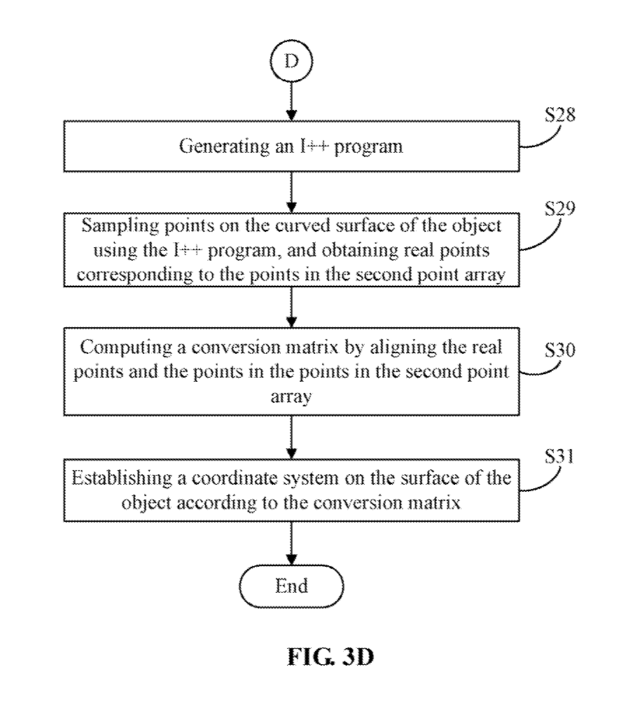

FIG. 2 is a block diagram of one embodiment of function modules of the coordinate system establishing system 10 in FIG. 1. In one embodiment, the coordinate system establishing system 10 may include a model constructing module 100, a first acquiring module 101, a second acquiring module 102, an aligning module 103, and a coordinate system establishing module 104. The function modules 100 to 104 provide at least the functions needed to execute the steps illustrated in FIGS. 3A to 3D below.

FIGS. 3A to 3D are flowcharts of one embodiment of a method for establishing coordinate system on the surface of the object 3. Depending on the embodiment, additional steps may be added, others removed, and the ordering of the steps may be changed.

Referring to FIG. 3A, in step S1, the model constructing module 100 loads a CAD file of the surface of the object 3 from the storage device 11, and constructs a three dimensional (3D) CAD model according to the CAD file. As mentioned, the CAD file includes controlling points, weights, and nodes of the surface. The model constructing module 100 constructs the CAD model utilizing the controlling points, the weights, and the nodes.

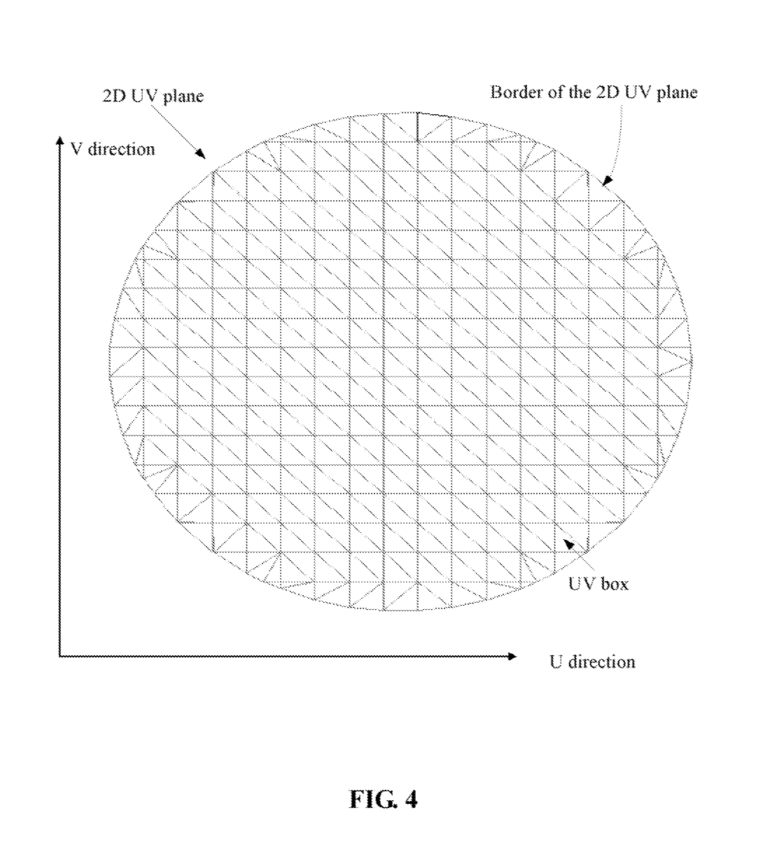

In step S2, the model constructing module 100 converts the CAD model to a two dimensional (2D) UV plane. The letters “U” and “V” denote a horizontal axis and vertical axis of a 2D plane. In one embodiment, the model constructing module 100 maps the CAD model into a 2D space to convert the CAD model to the UV plane. For example, if the CAD model is a sphere, it is represented in the UV plane as a circle. FIG. 4 is a schematic diagram of a two dimensional UV plane.

In step S3, the model constructing module 100 computes intersection points of borders of the UV plane and equidistant lines in a U direction and in a V direction, as shown in FIG. 4.

In step S4, the model constructing module 100 selects one of UV boxes which are formed by the equidistant lines. The UV boxes can be seen in FIG. 4.

In step S5, the model constructing module 100 determines if the selected UV box contains at least one of the intersection points. If the selected UV box contains at least one of the intersection points, the steps in FIG. 3B are implemented. Otherwise, if the selected UV box does not contain any one of the intersection points, the process goes to step S6.

In step S6, the model constructing module 100 divides the selected UV box into two triangles. Referring to FIG. 4. the model constructing module 100 connects diagonal of the UV box to divide a UV box into two triangles.

In step S7, the model constructing module 100 adds the two triangles into a triangle array. The process goes to step S1 after step S7.

Referring to FIG. 3B, in step S8, the model constructing module 100 obtains points including the vertexes of the selected UV box, wherein the vertexes are inside the borders of the UV plane, including the intersection points of the borders of the UV plane and the selected UV box, and including border points in the borders of the UV plane that are contained in the selected UV box.

In step S9, the model constructing module 100 adds the points into a first point array.

In step S10, the model constructing module 100 selects one point from the first point array as a first point. The selection of the first point may be random or according to a predetermined sequence.

In step S11, the model constructing module 100 selects one point which is nearest to the first point from the first point array as a second point.

In step S12, the model constructing module 100 further selects one point from the first point array as a third point, and constructs a triangle using the first point, the second point, and the third point. The third point may be any point in the first point array excluding the first point and the second point.

In step S13, the model constructing module 100 determines if any point in the first point array is contained in a circumscribed circle of the constructed triangle. If any point in the first point array is contained in a circumscribed circle of the constructed triangle, the process goes back to Step S12 Otherwise, if no point in the first point array is contained in a circumscribed circle of the constructed triangle, the process goes to step S14.

In step S14, the model constructing module 100 adds the constructed triangle into the triangle array.

In step S15, the model constructing module 100 determines if any point in the first point array has not been selected as the first point. If any point in the first point array has not been selected as the first point, the process goes back to step S10. Otherwise, if each of the points in the first point array have been selected as the first point, the process goes to step S16.

Referring to FIG. 3A again, in step S16, the model constructing module 100 determines if any one of the UV boxes has not been selected, if any one of the UV boxes has not been selected, the process goes back to step S4. Otherwise, if all the UV boxes have been selected, the process goes back to step S17.

In step S17, the model constructing module 100 triangularly meshes the CAD model according to the conversion between the CAD model and the UV plane, using the triangle array to generate a triangular mesh model.

Referring to FIG. 3C, in step S18, the first acquiring module 101 selects a point in the triangular mesh model, obtains a vector of a triangle which contains the selected point, and adds the selected point and the vector of the triangle which contains the selected point into a second point array.

In step S19, the first acquiring module 101 constructs a cubic box which is centered at the selected point and has a length of N units. In one embodiment, the length of the unit N is equal to lengths of the UV boxes.

In step S20, the first acquiring module 101 searches for a triangle from the triangular mesh model, wherein the triangle is contained in the cubic box and a distance between the center of the searched triangle and the selected point is greater than a predetermined distance, and an angle between a vector of the searched triangle and the triangle which contains the selected point is less than a predetermined angle.

In step S21, the first acquiring module 101 determines if the searched triangle exists. If the searched triangle does not exist, t he process goes to step S22. Otherwise, if the searched triangle exists, the process goes to step S23.

In step S22, the first acquiring module 101 replaces N with N+1. For example, if N=3, then the first acquiring module 101 replaces 3 with 4. After step S22, the process goes to step S19.

In step S23, the first acquiring module 101 computes a distance between a line and the CAD model, where the line is formed by the center of the searched triangle and the selected point.

In step S24, the first acquiring module 101 determines if the computed distance is less than a predetermined tolerance. If the computed distance is less than the predetermined tolerance, the process goes back to step S22 to replace N with N+1.

Otherwise, if the computed distance is not less than the predetermined tolerance, the process goes to step S25. In one embodiment, when the computed distance is less than the predetermined tolerance, the potential for collisions exists when the measurement device 2 measures the object 3.

In step S25, the first acquiring module 101 adds the center of the searched triangle and the vector of the searched triangle into the second point array.

In step S26, the first acquiring module 101 determines if a number of the points in the second point array has reached a predetermined number. If the number of the points in the second point array is less than the predetermined number, the process goes to step S27. Otherwise, if the number of the points in the second point array has reached the predetermined number, the steps in FIG. 3D are implemented.

In step S27, the first acquiring module 101 replaces the selected point with the center of the searched triangle. The process goes to step S19 after step S27.

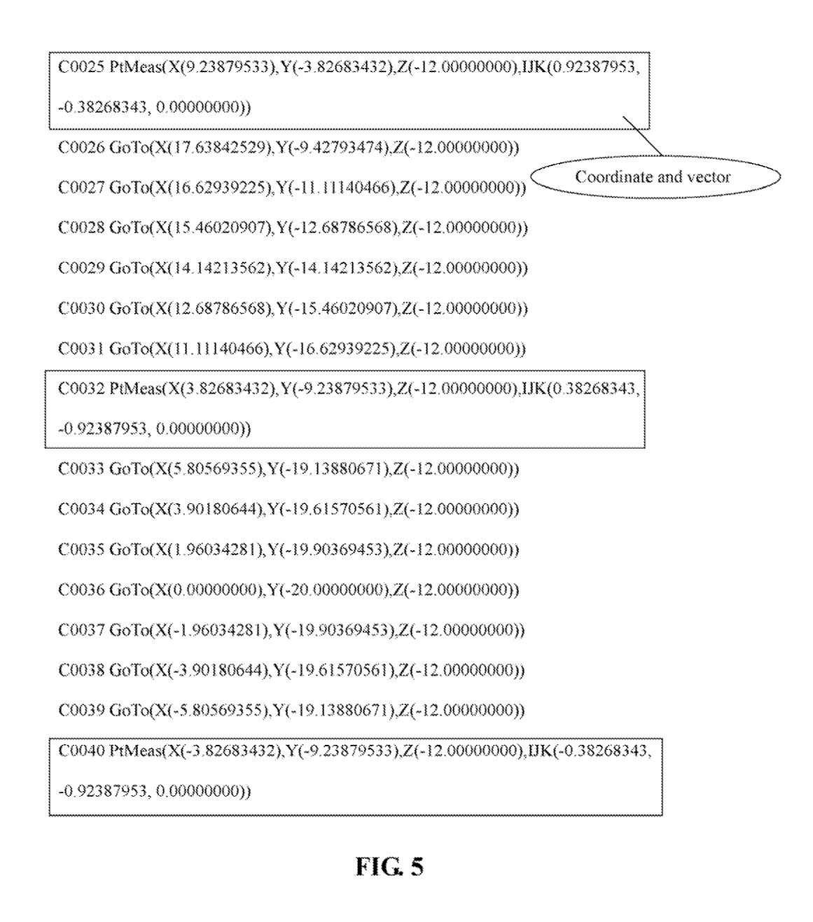

Referring to FIG. 3D, in step S28, the second acquiring module 102 generates an I++ measurement program which is used to sample points on the object 3 according to the points in the second point array. One example of an I++ measurement program is illustrated in FIG. 5. Referring to FIG. 5, the data after the label “PtMeas” comprises coordinates of the points in the second point array and the vectors in the second point array, and the data after the label “GoTo” comprises coordinates of safe points, such as proximity points, rebound point, void points, and so on.

In step S29, the second acquiring module 102 samples points on the surface of the object 3 using the I++ measurement program, and obtains real points corresponding to the points in the second point array. Such real points are points sampled on the surface of the object 3, and the points in the second point array are points selected on the CAD model of the surface of the object 3.

In step S30, the aligning module 103 computes a conversion matrix by aligning the real points and the points in the second point array.

In step S31, the coordinate system establishing module 104 establishes a coordinate system of the surface of the object 3 according to the conversion matrix.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A computerized method for establishing a coordinate system on a surface of an object, the method being executed by at least one processor of a computing device and comprising:
(a) constructing a three dimensional computer aided design (CAD) model of the surface of the object, and generating a triangular mesh model of the CAD model;
(b) selecting points from the triangular mesh model;
(c) sampling points on the surface of the object according to the selected points;
(d) computing a conversion matrix by aligning the sampled points and the selected points; and
(e) establishing the coordinate system according to the conversion matrix.

2. The method according to claim 1, wherein the step (a) comprises:
(a1) converting the CAD model to a two dimensional UV plane;
(a2) computing intersection points of borders of the UV plane and equidistant lines in a U direction and a V direction;
(a3) selecting a UV box which is formed by the equidistant lines one by one;
(a4) dividing the selected UV box into two triangles upon condition that the selected UV box does not contain any one of the intersection points; and
(a5) adding the two triangles into a triangle array, wherein the triangle array is used to generate the triangular mesh model.

3. The method according to claim 2, wherein the step (a) further comprises:
(a6) obtaining points including vertexes of the selected UV box, and adding the points into a first point array, wherein the vertexes are insides the borders of the UV plane, including the intersection points of the borders of the UV plane and the selected UV box, and including border points in the borders of the UV plane that are contained in the selected UV box;
(a7) selecting a point from the first point array as a first point one by one;
(a8) selecting a point which is nearest to the first point from the first point array as a second point;
(a9) selecting a point from the first point array as a third point, and constructing a triangle using the first point, the second point, and the third point;
(a10) returning to step (a9) upon condition that any point in the first point array is contained in a circumscribed circle of the constructed triangle; and
(a11) adding the constructed triangle into the triangle array upon condition that no point in the first point array is contained in a circumscribed circle of the constructed triangle.

4. The method according to claim 1, wherein step (b) comprises:
(b1) selecting a point in the triangular mesh model, obtaining a vector of a triangle which contains the selected point, and adding the selected point and the vector of the triangle which contains the selected point into a second point array;
(b2) constructing a cubic box which is centered at the selected point and has a length of N units;
(b3) searching a triangle from the triangular mesh model, wherein the triangle is contained in the cubic box and a distance between the center of the searched triangle and the selected point is greater than a predetermined distance, and an angle between a vector of the searched triangle and the triangle which contains the selected point is less than a predetermined angle;
(b4) computing a distance between a line and the CAD model, wherein the line is formed by the center of the searched triangle and the selected point;
(b5) adding the center of the searched triangle and the vector of the searched triangle into the second point array upon condition that the computed distance is not less than a predetermined tolerance; and
(b6) replacing the selected point with the center of the searched triangle, and returning to step (b2) until a number of the points in the second point array reaches a predetermined number.

5. The method according to claim 4, wherein step (c) comprises:
generating an I++ measurement program which is used to sample points on the object according to the points in the second point array.

6. A computing device, comprising:
a storage device;
at least one processor; and
one or more modules that are stored in the storage device, and are executed by the at least one processor, the one or more modules comprising instructions to:
(a) construct a three dimensional computer aided design (CAD) model of the surface of the object, and generate a triangular mesh model of the CAD model;
(b) select points from the triangular mesh model;
(c) sample points on the surface of the object according to the selected points;
(d) compute a conversion matrix by aligning the sampled points and the selected points; and
(e) establish the coordinate system according to the conversion matrix.

7. The computing device according to claim 6, wherein the one or more modules further comprise instructions in step (a) to:
(a1) convert the CAD model to a two dimensional UV plane;
(a2) compute intersection points of borders of the UV plane and equidistant lines in a U direction and a V direction;
(a3) select a UV box which is formed by the equidistant lines one by one;
(a4) divide the selected UV box into two triangles upon condition that the selected UV box does not contain any one of the intersection points; and
(a5) add the two triangles into a triangle array, wherein the triangle array is used to generate the triangular mesh model.

8. The computing device according to claim 7, wherein the one or more modules further comprise instructions in step (a) to:
(a6) obtain points including vertexes of the selected UV box, and adding the points into a first point array, wherein the vertexes are insides the borders of the UV plane, including the intersection points of the borders of the UV plane and the selected UV box, and including border points in the borders of the UV plane that are contained in the selected UV box;
(a7) select a point from the first point array as a first point one by one;
(a8) select a point which is nearest to the first point from the first point array as a second point;
(a9) select a point from the first point array as a third point, and construct a triangle using the first point, the second point, and the third point;
(a10) return to step (a9) upon condition that any point in the first point array is contained in a circumscribed circle of the constructed triangle; and
(a11) add the constructed triangle into the triangle array upon condition that no point in the first point array is contained in a circumscribed circle of the constructed triangle.

9. The computing device according to claim 6, wherein the one or more modules further comprise instructions in step (b) to:
(b1) select a point in the triangular mesh model, obtain a vector of a triangle which contains the selected point, and add the selected point and the vector of the triangle which contains the selected point into a second point array;
(b2) construct a cubic box which is centered at the selected point and has a length of N units;
(b3) search a triangle from the triangular mesh model, wherein the triangle is contained in the cubic box and a distance between the center of the searched triangle and the selected point is greater than a predetermined distance, and an angle between a vector of the searched triangle and the triangle which contains the selected point is less than a predetermined angle;
(b4) compute a distance between a line and the CAD model, wherein the line is formed by the center of the searched triangle and the selected point;
(b5) add the center of the searched triangle and the vector of the searched triangle into the second point array upon condition that the computed distance is not less than a predetermined tolerance; and
(b6) replace the selected point with the center of the searched triangle, and return to step (b2) until a number of the points in the second point array reaches a predetermined number.

10. The computing device according to claim 9, wherein the one or more modules further comprise instructions in step (c) to:
generate an I++ measurement program which is used to sample points on the object according to the points in the second point array.

11. A non-transitory storage medium having stored thereon instructions that, when executed by a processor of a computing device, causes the processor to perform a method for establishing coordinate system on a surface of an object, wherein the method comprises:
(a) constructing a three dimensional computer aided design (CAD) model of the surface of the object, and generating a triangular mesh model of the CAD model;
(b) selecting points from the triangular mesh model;
(c) sampling points on the surface of the object according to the selected points;
(d) computing a conversion matrix by aligning the sampled points and the selected points; and
(e) establishing the coordinate system according to the conversion matrix.

12. The non-transitory storage medium according to claim 11, wherein the step (a) comprises:
(a1) converting the CAD model to a two dimensional UV plane;
(a2) computing intersection points of borders of the UV plane and equidistant lines in a U direction and a V direction;
(a3) selecting a UV box which is formed by the equidistant lines one by one;
(a4) dividing the selected UV box into two triangles upon condition that the selected UV box does not contain any one of the intersection points; and
(a5) adding the two triangles into a triangle array, wherein the triangle array is used to generate the triangular mesh model.

13. The non-transitory storage medium according to claim 12, wherein the step (a) further comprises:
(a6) obtaining points including vertexes of the selected UV box, and adding the points into a first point array, wherein the vertexes are insides the borders of the UV plane, including the intersection points of the borders of the UV plane and the selected UV box, and including border points in the borders of the UV plane that are contained in the selected UV box;
(a7) selecting a point from the first point array as a first point one by one;
(a8) selecting a point which is nearest to the first point from the first point array as a second point;
(a9) selecting a point from the first point array as a third point, and constructing a triangle using the first point, the second point, and the third point;
(a10) returning to step (a9) upon condition that any point in the first point array is contained in a circumscribed circle of the constructed triangle; and
(a11) adding the constructed triangle into the triangle array upon condition that no point in the first point array is contained in a circumscribed circle of the constructed triangle.

14. The non-transitory storage medium according to claim 11, wherein step (b) comprises:
(b1) selecting a point in the triangular mesh model, obtaining a vector of a triangle which contains the selected point, and adding the selected point and the vector of the triangle which contains the selected point into a second point array;
(b2) constructing a cubic box which is centered at the selected point and has a length of N units;
(b3) searching a triangle from the triangular mesh model, wherein the triangle is contained in the cubic box and a distance between the center of the searched triangle and the selected point is greater than a predetermined distance, and an angle between a vector of the searched triangle and the triangle which contains the selected point is less than a predetermined angle;
(b4) computing a distance between a line and the CAD model, wherein the line is formed by the center of the searched triangle and the selected point;
(b5) adding the center of the searched triangle and the vector of the searched triangle into the second point array upon condition that the computed distance is not less than a predetermined tolerance; and
(b6) replacing the selected point with the center of the searched triangle, and returning to step (b2) until a number of the points in the second point array reaches a predetermined number.

15. The non-transitory storage medium according to claim 14, wherein step (c) comprises:
generating an I++ measurement program which is used to sample points on the object according to the points in the second point array.
